(19) United States
(12) Patent Application Publication
(10) Pub. No.: US 2026/0079320 A1
(43) Pub. Date: Mar. 19, 2026

(54) DRIVING MECHANISM

(71) Applicant: TDK TAIWAN CORP., Taoyuan City (TW)

(72) Inventors: Jui-Ta CHIEN, Taoyuan CIty (TW); Po-Xiang ZHUANG, Taoyuan CIty (TW); Kun-Shih LIN, Taoyuan CIty (TW)

(21) Appl. No.: 19/327,464

(22) Filed: Sep. 12, 2025

Related U.S. Application Data
(60) Provisional application No. 63/694,389, filed on Sep. 13, 2024.

(51) Int. Cl. G02B 7/09; G02B 27/64

(52) U.S. Cl. CPC G02B 7/09; G02B 27/646

(57) ABSTRACT

A driving mechanism for moving an optical element is provided. The driving mechanism includes a fixed part, a movable part, and a driving assembly. The movable part is movably connected to the fixed part for holding the optical element. The driving assembly is configured to move the optical element relative to the fixed part.

### CROSS REFERENCE TO RELATED APPLICATIONS

This application claims the benefit of U.S. provisional application No. 63/694,389, filed Sep. 13, 2024, the entirety of which is incorporated by reference herein.

### BACKGROUND OF THE INVENTION

### FIELD OF THE INVENTION

The present invention relates to a driving mechanism, and, in particular, it relates to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

Electronic devices usually use several coils and magnets to adjust the focus of a lens. However, miniaturization of these electronic devices may increase the difficulty of mechanical design, and this may also lead to low reliability and a lower positioning accuracy of the driving mechanism. It has been a challenge to address this problem.

### BRIEF SUMMARY OF THE INVENTION

An embodiment of the present invention provides a driving mechanism for moving an optical element. The driving mechanism includes a fixed part, a movable part, and a driving assembly. The movable part is movably connected to the fixed part for holding the optical element. The driving assembly is configured to move the optical element relative to the fixed part.

In some embodiments, the fixed part has a housing and a base affixed to each other. The base has a main body, a metal frame, and a stopper. The stopper is configured to contact the movable part, the main body forms a through hole, and the stopper is disposed in the through hole. Additionally, the metal frame is embedded in the main body and the stopper.

### BRIEF DESCRIPTION OF THE DRAWINGS

The present invention can be more fully understood by reading the subsequent detailed description and examples with references made to the accompanying drawings, wherein:

FIG. 1 shows an exploded view of a driving mechanism 100 according to an embodiment of the present invention.

FIG. 2 shows another exploded view of the driving mechanism 100 in FIG. 1.

FIG. 3 shows a perspective diagram of the driving mechanism 100 in FIGS. 1 and 2 after assembly.

FIG. 4 is a partially enlarged view of the driving mechanism 100 shown in FIG. 3 with the housing H and the stopper K removed.

FIG. 5 shows a schematic diagram of a buffer element G that is disposed in the recess LH1 and connected to the positioning elements N, the stopper K, and the magnetic element M2.

FIG. 6 shows an enlarged partial cross-sectional view of the base B, the magnetic element M1, the magnetic permeable plate Q, the frame F, and the coil C1 after assembly.

FIG. 7 shows an exploded view of the base B in FIG. 1.

FIG. 8 shows a perspective diagram of the guide rod R connected to the metal frame BM of the base B.

FIG. 9 shows another perspective diagram of the base B.

FIG. 10 is a schematic diagram showing that the frame F is spaced apart from the stoppers G1 and G2 on the metal frame BM by the distances g1 and g2, respectively.

FIG. 11 shows a partial enlarged cross-sectional view of the base B.

FIG. 12 shows another partial enlarged cross-sectional view of the base B.

FIG. 13 shows a perspective diagram of the connection structure T of the metal frame BM that protrudes from the edge of the main body BP.

FIG. 14 shows another perspective diagram of the connection structure T of the metal frame BM that protrudes from the edge of the main body BP.

FIG. 15 shows a partial enlarged side view of the housing H and the base B after assembly.

FIG. 16 shows a partial enlarged bottom view of the base B and the housing H after assembly.

FIG. 17 shows another partial enlarged cross-sectional view of the base B and the housing H after assembly.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

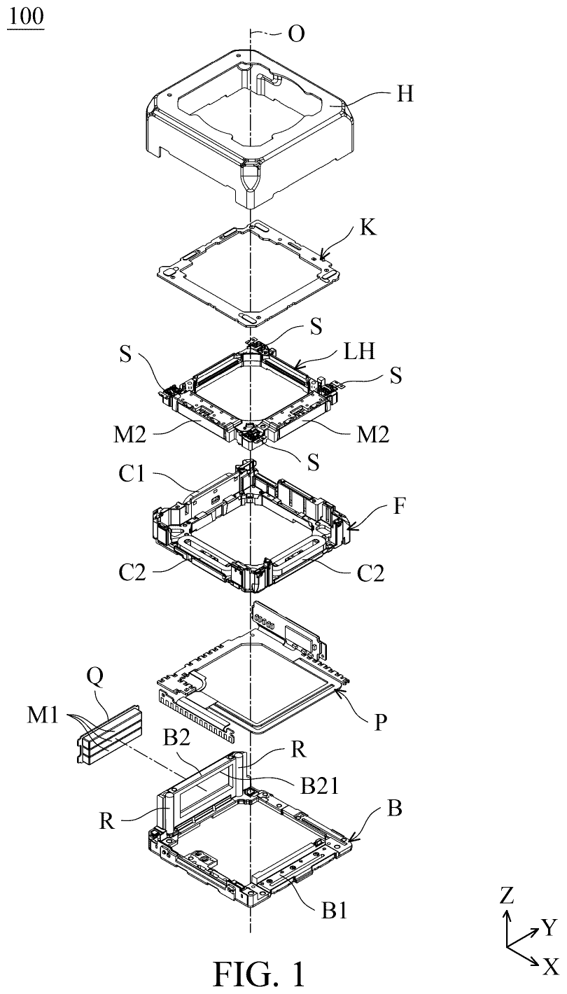

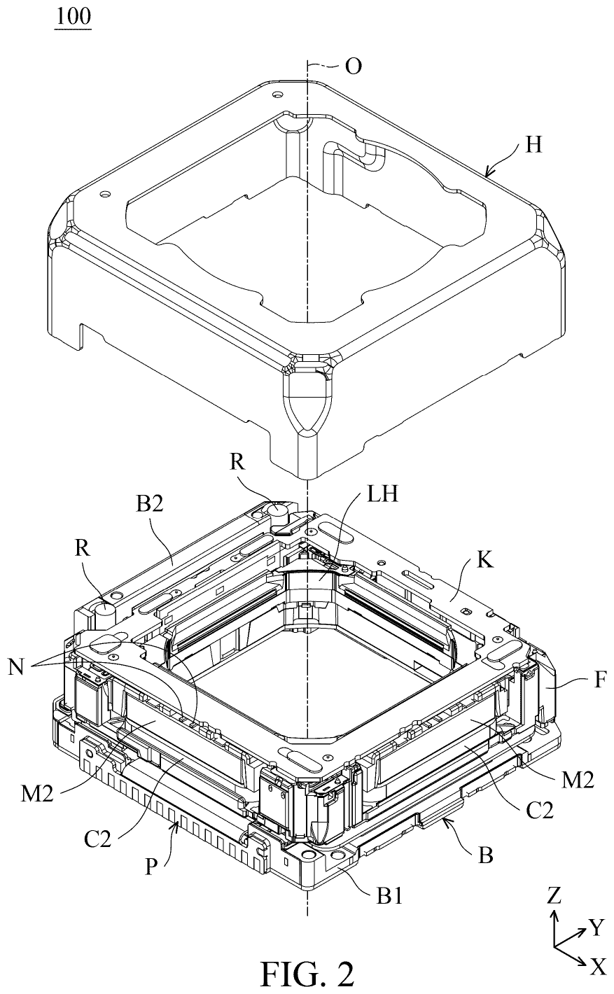

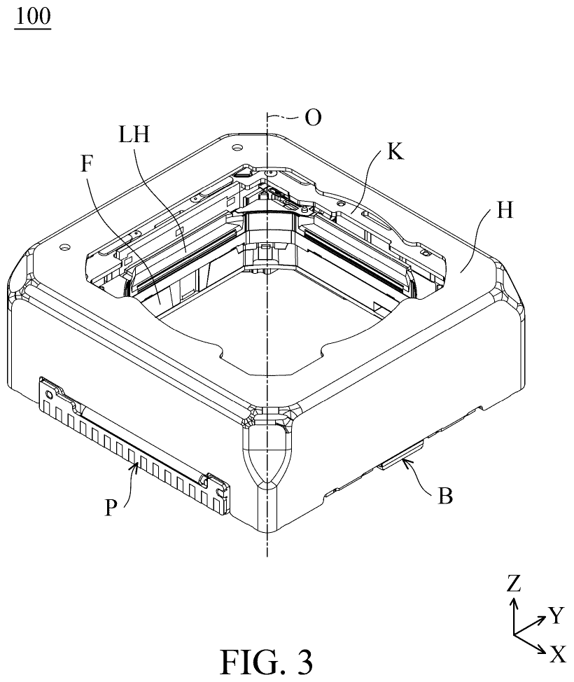

FIG. 1 shows an exploded view of a driving mechanism 100 according to an embodiment of the present invention. FIG. 2 shows another exploded view of the driving mechanism 100 in FIG. 1. FIG. 3 shows a perspective diagram of the driving mechanism 100 in FIGS. 1 and 2 after assembly.

As shown in FIGS. 1, 2, and 3, the driving mechanism 100 in this embodiment is a voice coil motor (VCM), which can be installed in a mobile phone or other portable electronic device to drive an optical element (e.g. an optical lens) to move, thereby achieving the functions of auto focusing (AF) and optical image stabilization (OIS).

The driving mechanism 100 includes a hollow housing H, a base B, a circuit assembly P, a holder LH, a frame F, a stopper K, a plurality of sheet springs S, a plurality of guide rods R, a plurality of magnetic elements M1, M2 (e.g. magnets), and a plurality of coils C1, C2. The stopper K may comprise metal, and the base B, the holder LH, and the frame F may comprise plastic or fiberglass.

In this embodiment, the housing H has a hollow structure and is joined with the base B. The circuit assembly P is disposed between the frame F and the base B, thereby electrically connecting the coils C1 and C2 to an external circuit.

It should be noted that the housing H and base B constitute a fixed part of the driving mechanism 100. The base B has a rectangular structure B1 and a wall portion B2 protruding from the rectangular structure B1 in the Z direction. The magnetic elements M1 are affixed in an opening B21 of the wall portion B2, and a magnetic permeable plate Q is disposed on the outer side of the magnetic elements M1 to enhance the electromagnetic driving force of the driving mechanism 100.

The holder LH is movably disposed in the housing H, and an optical element (not shown) may be disposed in the holder LH. The holder LH and the frame F constitute a movable part that can move relative to the fixed part (the housing H and the base B), and the optical element has an optical axis O parallel to the Z axis.

Here, the holder LH is connected to the frame F via the sheet springs S, thus allowing the holder LH to move relative to the frame F along the X axis and/or the Y axis. The guide rod R is sandwiched between the frame F and the wall portion B2 of the base B, thus allowing the frame F to move relative to the base B along the Z axis. Furthermore, the stopper K is affixed to the top side of the frame F, thus preventing the holder LH from falling off the frame F.

It should be noted that coils C1 and C2 are both mounted on the frame F, and the magnetic elements M2 are mounted on the holder LH. The position of coil C1 corresponds to the magnetic element M1 on the base B, and the position of coil C2 corresponds to the magnetic element M2 on the frame F. Here, the coils C1, C2 and magnetic elements M1, M2 constitute a driving assembly that can drive the frame F and holder LH to move relative to the fixed portion (the housing H and the base B), thereby achieving the functions of auto focusing (AF) and optical image stabilization (OIS).

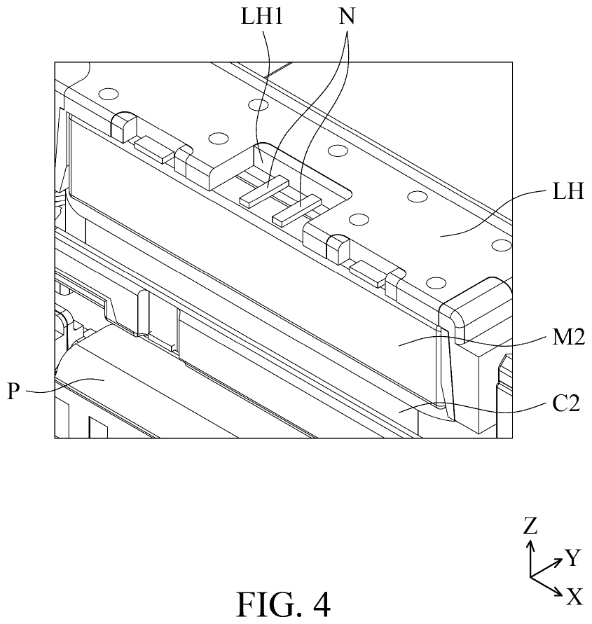

FIG. 4 is a partially enlarged view of the driving mechanism 100 shown in FIG. 3 with the housing H and the stopper K removed.

As shown in FIG. 4, a recess LH1 is formed on the outer side of the holder LH, and at least one elongated positioning element N is disposed in the recess LH1. In this embodiment, two positioning elements N are provided in the recess LH1 and extend in the −Y direction (first direction).

The positioning elements N may be thin metal pins that are embedded in the holder LH by insert molding. The magnetic element M2 is located between the positioning element N and the coil C2 along the Z axis. The positioning elements N may comprise magnetic permeable material, but the material and shape of the positioning element N are not limited to those disclosed in the embodiments of the present invention.

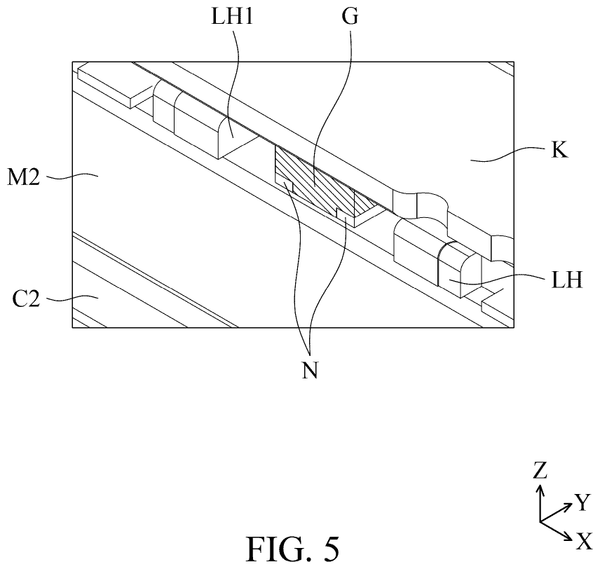

FIG. 5 shows a schematic diagram of a buffer element G that is disposed in the recess LH1 and connected to the positioning elements N, the stopper K, and the magnetic element M2.

As shown in FIG. 5, during assembly of the driving mechanism 100, a buffer element G (e.g. damping gel) may be disposed in the recess LH1 of the holder LH and in contact with the positioning element N, the stopper K, and the magnetic element M2.

With the buffer element G disposed between the stopper K and the magnetic element M2, the impact force of the holder LH when it contacts the stopper K during movement relative to the frame F along the Z axis can be reduced. Moreover, the buffer element G can also be used to absorb the vibration generated by the driving mechanism 100 during operation.

Additionally, since a part of the buffer element G is located between the two parallel positioning elements N, the buffer element G can be effectively prevented from falling off the recess LH1 of the holder LH, whereby the stability and reliability of the driving mechanism 100 can be improved.

In some embodiments, the buffer element G may not contact the magnetic element M2, and it may be connected between the stopper K and the frame F to absorb the vibration generated by the driving mechanism 100 during operation. Therefore, the present invention is not limited to the embodiments disclosed herein.

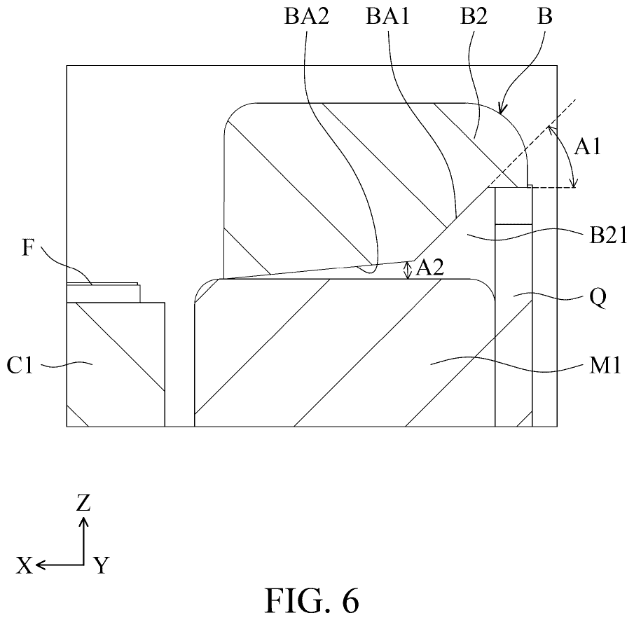

FIG. 6 shows an enlarged partial cross-sectional view of the base B, the magnetic element M1, the magnetic permeable plate Q, the frame F, and the coil C1 after assembly.

During assembly of the driving mechanism 100, as shown in FIG. 6, the magnetic element M1 and the magnetic permeable plate Q are installed into the opening B21 from the outer side of the wall portion B2 of the base B in the X direction. Here, the magnetic element M1 is located adjacent to the coil C1 on the frame F.

It should be noted that the opening B21 has a tapered structure extending in the X direction. The tapered structure has a first side surface BA1 and a second side surface BA2 that are connected to each other. The first side surface BA1 has a first sloped angle A1 relative to the X direction, and the second side surface BA2 has a second sloped angle A2 relative to the X direction. In this embodiment, the first sloped angle A1 is greater than the second sloped angle A2, thereby improving the positioning accuracy and enabling easy and convenient assembly of the magnetic elements M1.

In this embodiment, the first sloped angle A1 is within a range of 15 to 75 degrees, and the second sloped angle A2 is less than 3 degrees. However, the ranges of the first sloped angle A1 and the second sloped angle A2 can be adjusted according to design requirements and are not limited to those disclosed in the embodiments of the present invention.

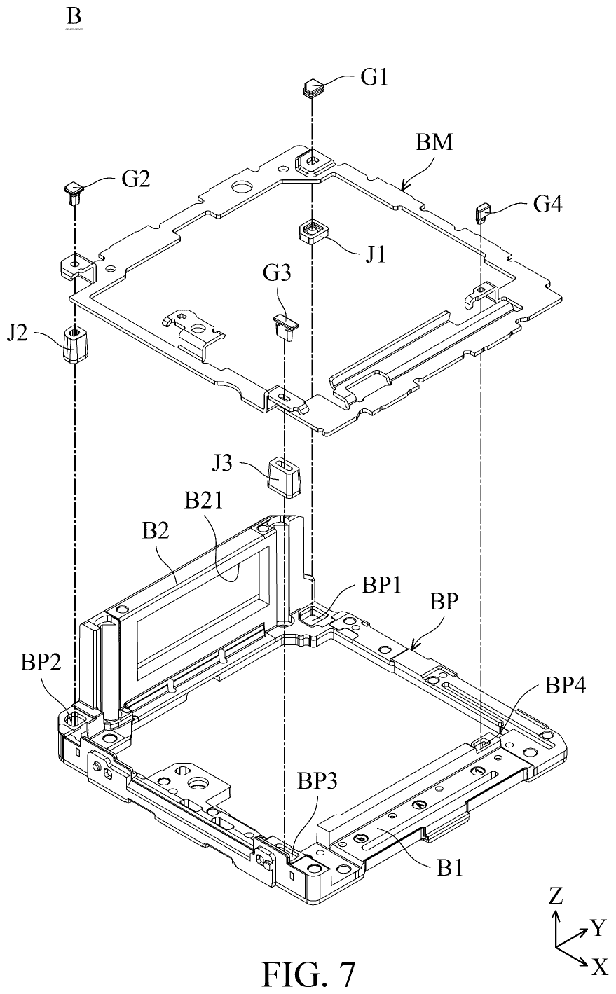

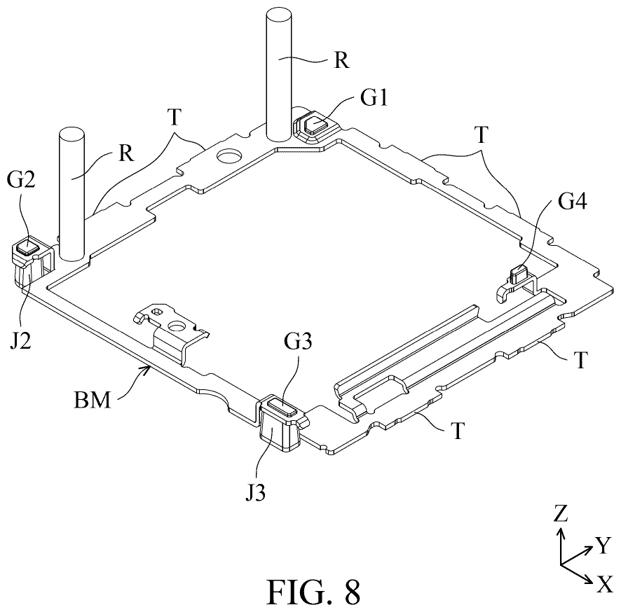

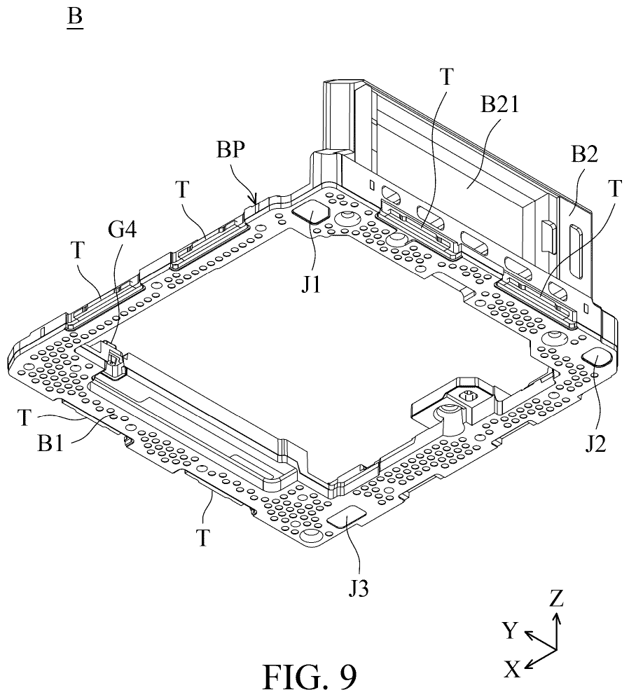

FIG. 7 shows an exploded view of the base B in FIG. 1. FIG. 8 shows a perspective diagram of the guide rod R connected to the metal frame BM of the base B. FIG. 9 shows another perspective diagram of the base B.

As shown in FIGS. 7, 8, and 9, the base B primarily comprises a main body BP and a metal frame BM. The main body BP includes the rectangular structure B1 and the wall portion B2. The metal frame BM is embedded in the main body BP by insert molding. For example, the main body BP may comprise plastic or fiberglass.

It should be noted that the base B further comprises four stoppers G1, G2, G3, G4 and three connecting members J1, J2, J3. Moreover, four through holes BP1, BP2, BP3, BP4 are formed on the rectangular structure B1 of the main body BP and located corresponding to the stoppers G1, G2, G3, G4.

In this embodiment, the stoppers G1, G2, G3 and the connecting members J1, J2, J3 may be formed in the through holes BP1, BP2, BP3 by two-shot injection molding. The stoppers G1, G2, G3, G4 are located close to the four respective corners of the quadrilateral base B.

The stoppers G1, G2, G3, and G4 may comprise rubber or silicone, so as to contact the frame F and restrict the movement of the frame F within a range along the Z axis. Specifically, the material of the stoppers G1, G2, G3, and G4 is different from the material of the connecting members J1, J2, and J3.

Here, the stopper G1 and the connecting member J1 are joined in the through hole BP1, the stopper G2 and the connecting member J2 are joined in the through hole BP2, the stopper G3 and the connecting member J3 are joined in the through hole BP3, and the stopper G4 is joined in the through hole BP4. All of the stoppers G1, G2, G3, and G4 have a flat top surface, wherein the areas and shapes of the top surfaces are different.

Referring to FIG. 8, the metal guide rods R are directly connected to the metal frame BM. In this embodiment, the guide rod R and metal frame BM may be integrally formed with the main body BP in one piece by insert molding. Furthermore, as shown in FIGS. 8 and 9, the stoppers G1, G2, G3, G4 are exposed to the top side of the main body BP of the base B, and the connecting members J1, J2, J3 are exposed to the bottom side of the main body BP of the base B.

It can be seen in FIGS. 8 and 9 that at least one connection structure T is formed on one side of the metal frame BM, protruding from the edge of the main body BP. During assembly of the driving mechanism 100, the metal housing H and the connection structure T can be affixed to each other by welding or soldering.

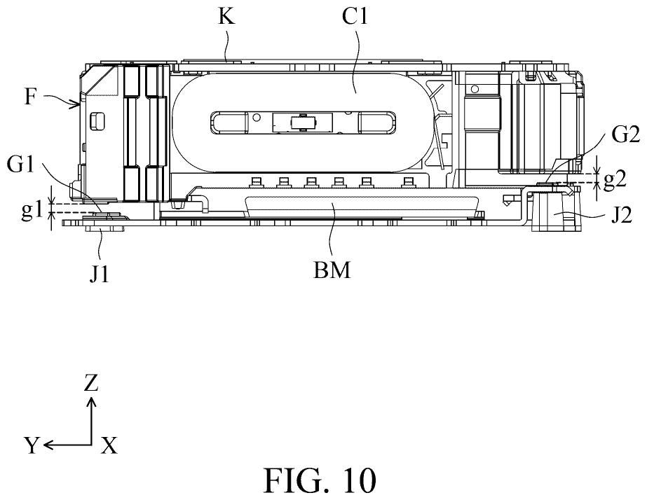

FIG. 10 is a schematic diagram showing that the frame F is spaced apart from the stoppers G1 and G2 on the metal frame BM by the distances g1 and g2, respectively.

As shown in FIG. 10, after assembly of the driving mechanism 100, the frame F is spaced apart from the stoppers G1 and G2 on the metal frame BM by the distances g1 and g2, respectively. When a current signal is applied to the coil C1 on the frame F, the coil C1 and the magnetic element M1 on the base B can generate an electromagnetic driving force, whereby the frame F and the holder LH can be driven to move along the Z axis to achieve the functions of auto focusing (AF) and/or optical image stabilization (OIS) along the Z axis.

In this embodiment, the stoppers G1 and G2 face the frame F. The frame F is separated from the stopper G1 by the distance g1 along the Z axis, and the frame F is separated from the other stopper G2 by the distance g2 along the Z axis, wherein the distance g1 is substantially equal to the distance g2.

In addition, the position of the stopper G2 in the Z direction is higher than the position of the stopper G1 in the Z direction, and the hardness of the stoppers G1 and G2 is lower than the hardness of the frame F.

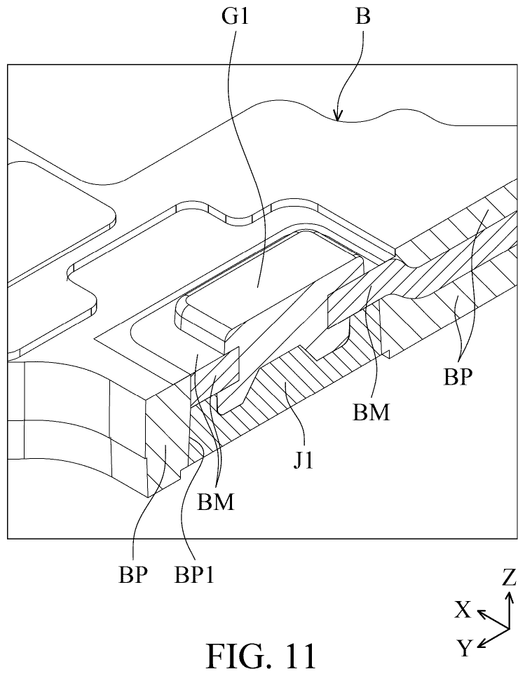

FIG. 11 shows a partial enlarged cross-sectional view of the base B. As shown in FIG. 11, after the stopper G1, the connecting member J1, the metal frame BM, and the main body BP are formed and joined to each other, the metal frame BM extends into the through hole BP1 of the main body BP and engages with the stopper G1. Here, the stopper G1 protrudes from the top side of the main body BP in the Z direction.

Still referring to FIG. 11, the connecting member J1 located on the bottom side of the metal frame BM is in contact with the stopper G1, the metal frame BM and the inner wall of the through hole BP1 of the main body BP. In this configuration, the stopper G1 is surrounded by the metal frame BM but not in contact with the main body BP.

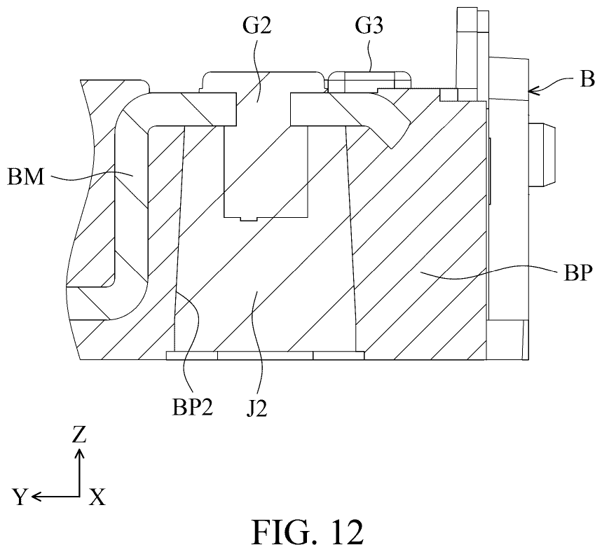

FIG. 12 shows another partial enlarged cross-sectional view of the base B. As shown in FIG. 12, after the stopper G2, the connecting member J2, the metal frame BM, and the main body BP are formed and joined to each other, the metal frame BM extends into the through hole BP2 of the main body BP and engages with the stopper G2. Here, the stopper G2 protrudes from the top side of the main body BP in the Z direction.

Still referring to FIG. 12, the connecting member J2 located on the bottom side of the metal frame BM is in contact with the stopper G2, the metal frame BM and the inner wall of the through hole BP2 of the main body BP. In this configuration, the stopper G2 is surrounded by the metal frame BM but not directly in contact with the main body BP.

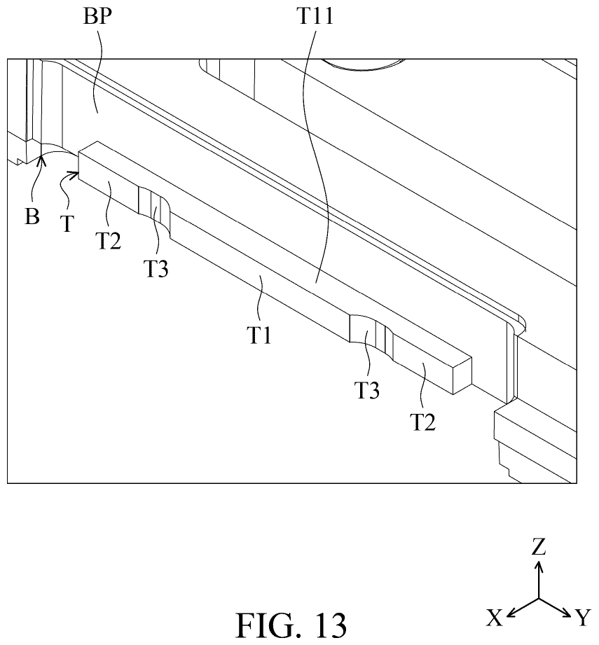

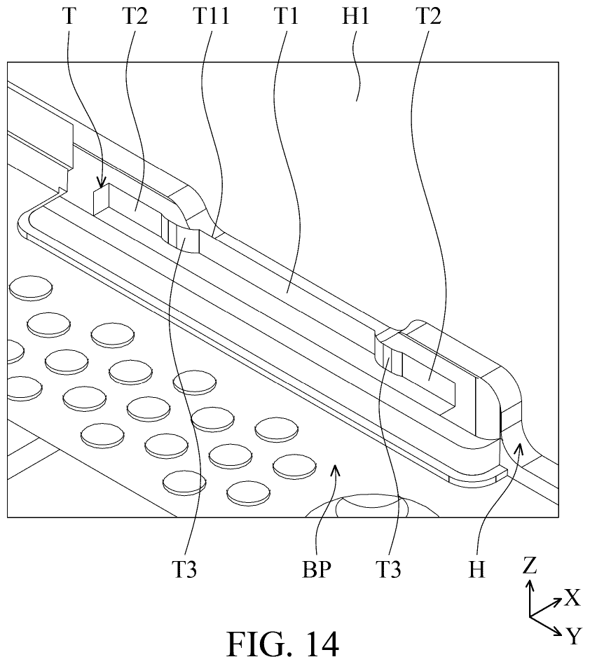

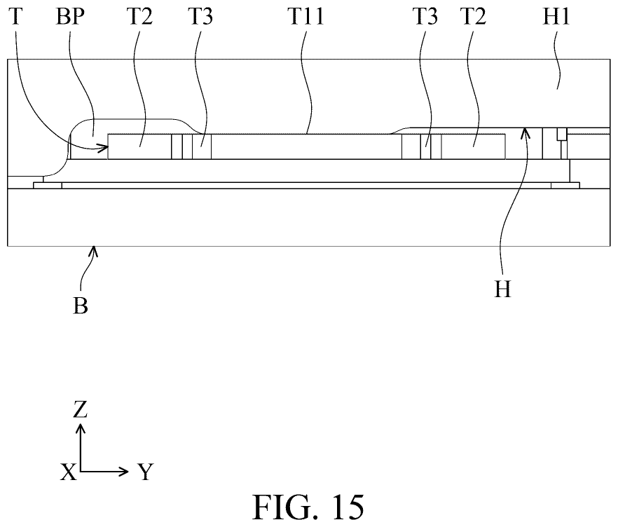

FIG. 13 shows a perspective diagram of the connection structure T of the metal frame BM that protrudes from the edge of the main body BP. FIG. 14 shows another perspective diagram of the connection structure T of the metal frame BM that protrudes from the edge of the main body BP. FIG. 15 shows a partial enlarged side view of the housing H and the base B after assembly.

As shown in FIG. 13, one of the connection structures T of the metal frame BM protrudes from the edge of the main body BP in a horizontal direction (X direction). The connection structure T includes a bonding portion T1, two side portions T2, and two recessed portions T3. The side portions T2 are located on opposite sides of the bonding portion T1, and the recessed portions T3 are connected between the side portions T2 and the bonding portion T1.

It can be seen in FIGS. 13 and 14 that the bonding portion T1 of the connection structure T protrudes further from the main body BP in the X direction than the two side portions T2. During assembly, the upper surface T11 of the bonding portion T1 is adjacent to and faces the housing H. Thus, the housing H and the base B can be bonded to each other by welding or soldering, and reliability and durability of the driving mechanism 100 can be improved.

It should be noted that the connection structure T in this embodiment does not protrude from the outer surface H1 of the housing H in the X direction. In this configuration, the solder can be applied and accommodated in the space formed adjacent to the edges of the housing H and the connection structure T.

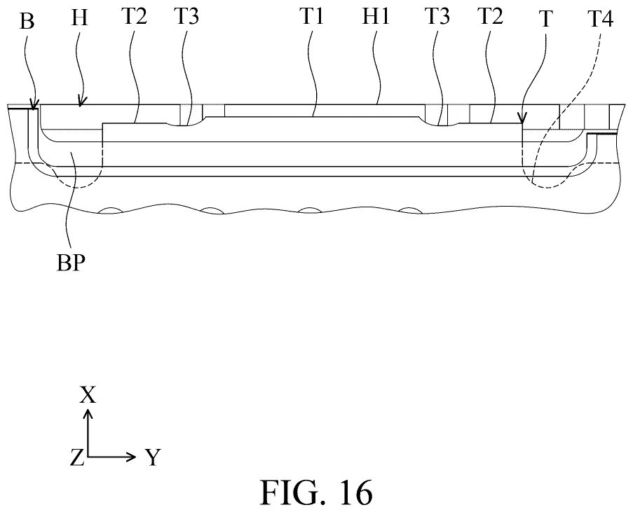

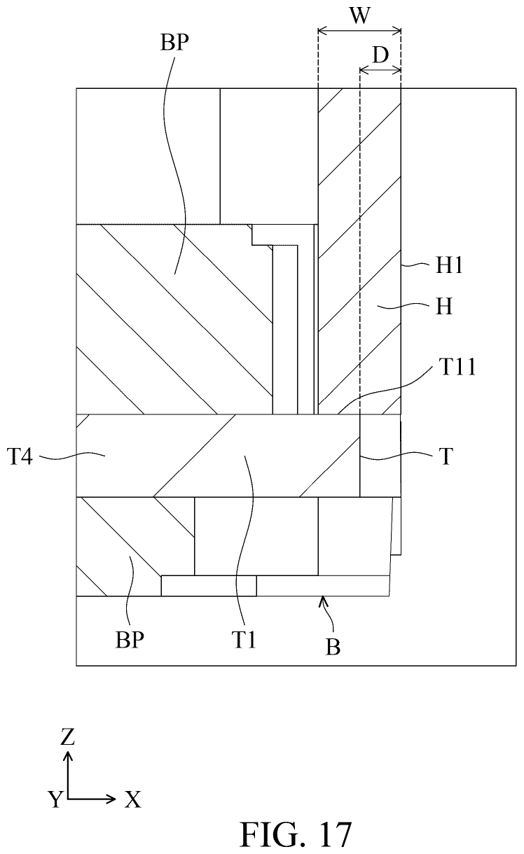

FIG. 16 shows a partial enlarged bottom view of the base B and the housing H after assembly. FIG. 17 shows another partial enlarged cross-sectional view of the base B and the housing H after assembly.

As shown in FIGS. 16 and 17, the connection structure T of the metal frame BM further has an embedded portion T4 that is embedded and hidden in the main body BP of the base B. It should be noted that the bonding portion T1 of the connection structure T protrudes from the edge of the main body BP in the X direction. However, the bonding portion T1 does not protrude from the outer surface H1 of the housing H in the X direction.

As can be seen in FIG. 16, when viewed along the Z axis, the bonding portion T1 and the two side portions T2 of the connection structure T at least partially overlap the housing H. Specifically, the distance between the side portions T2 and the outer surface H1 is greater than the distance between the bonding portion T1 and the outer surface H1.

Referring to FIG. 17, the housing H has a thickness W along the X axis, wherein the bonding portion T1 of the connection structure T is spaced apart from the outer surface H1 of the housing H by a distance of D along the X axis. Here, the distance D is greater than ⅓ of the thickness W. In this configuration, a space for accommodating the solder can be reserved, thereby improving the connection strength and easy assembly of the base B and the housing H when they are bonded to each other by welding or soldering. Additionally, the structural integrity of the driving mechanism 100 can also be maintained.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for driving an optical element to move, wherein the optical element has an optical axis, and the driving mechanism comprises:
a fixed part;
a movable part, movably connected to the fixed part for holding the optical element; and
a driving assembly, configured to drive the movable part to move relative to the fixed part.

2. The driving mechanism as claimed in claim 1, wherein the fixed part has a housing and a base affixed to each other, the base has a main body, a metal frame and a stopper, the stopper is configured to contact the movable part, the main body forms a through hole, and the stopper is disposed in the through hole, wherein the metal frame is embedded in the main body and the stopper.

3. The driving mechanism as claimed in claim 2, wherein the base further has a connecting member disposed in the through hole and in contact with the stopper, the metal frame, and the main body.

4. The driving mechanism as claimed in claim 3, wherein the stopper is surrounded by the metal frame, and the stopper is not in contact with the main body.

5. The driving mechanism as claimed in claim 3, wherein the stopper is exposed to the top side of the main body, and the connecting member is exposed to the bottom side of the main body.

6. The driving mechanism as claimed in claim 3, wherein the stopper and connecting member comprise different materials.

7. The driving mechanism as claimed in claim 6, wherein the stopper comprises rubber or silicone.

8. The driving mechanism as claimed in claim 6, wherein the stopper and the connecting member are formed in the through hole by two-shot injection molding.

9. The driving mechanism as claimed in claim 2, wherein the main body further forms a plurality of through holes, and the base further has a plurality of stoppers disposed in the through holes, wherein the stoppers are located in different positions along the optical axis.

10. The driving mechanism as claimed in claim 9, wherein the hardness of the stoppers is lower than the hardness of the movable part.

11. The driving mechanism as claimed in claim 9, wherein the stoppers respectively have a flat top surface, and the areas of the top surfaces are different.

12. The driving mechanism as claimed in claim 9, wherein the base has a quadrilateral structure, and the stoppers are located close to the respective corners of the base.

13. The driving mechanism as claimed in claim 2, further comprising a guide rod movably connected between the movable part and the fixed part, wherein the movable part is movable relative to the fixed part along the optical axis, and the guide rod comprises metal and is connected to the metal frame.

14. The driving mechanism as claimed in claim 1, wherein the fixed part has a housing and a base affixed to each other, and the base has a main body and a metal frame, wherein the metal frame is embedded in the main body and has a connection structure, the connection structure protrudes from the edge of the main body in a horizontal direction and connects to the housing, and the horizontal direction is perpendicular to the optical axis.

15. The driving mechanism as claimed in claim 14, wherein the connection structure has an embedded portion and a bonding portion, the embedded portion is embedded in the main body, and the bonding portion has an upper surface located adjacent to the housing.

16. The driving mechanism as claimed in claim 15, wherein the housing has a thickness in the horizontal direction, and the bonding portion is spaced apart from an outer surface of the housing by a distance, wherein the distance is greater than ⅓ of the thickness.

17. The driving mechanism as claimed in claim 16, wherein the connection structure further has two side portions and two recessed portions, the side portions are located on opposite sides of the bonding portion, and the recessed portions are connected between the side portions and the bonding portion.

18. The driving mechanism as claimed in claim 17, wherein the side portions at least partially overlap the housing when viewed along the optical axis.

19. The driving mechanism as claimed in claim 17, wherein the distance between the side portions and the outer surface is greater than the distance between the bonding portion and the outer surface.

20. The driving mechanism as claimed in claim 17, wherein the bonding portion protrudes further from the main body in the horizontal direction than the side portions.
